(19) United States
(12) Patent Application Publication
(10) Pub. No.: US 2014/0310155 A1
(43) Pub. Date: Oct. 16, 2014

(54) SYSTEM AND METHOD FOR GROUP FINANCIAL RATE MANAGEMENT

(71) Applicant: Richard Postrel, Miami Beach, FL (US)

(72) Inventor: Richard Postrel, Miami Beach, FL (US)

(21) Appl. No.: 14/250,778

(22) Filed: Apr. 11, 2014

Related U.S. Application Data
(60) Provisional application No. 61/811,068, filed on Apr. 11, 2013.

(51) Int. Cl. G06Q 50/00

(52) U.S. Cl. CPC G06Q 50/01; G06Q 40/025
USPC 705/38

(57) ABSTRACT

A method of and system for operating a financial-based social network. A financial social network server computer forms a financial social network comprising a plurality of members linked to each other, then generates a financial member profile for each member, then generates a financial network profile based on an analysis of the financial member profiles of the members, then generates a base financial rate of the financial social network as a function of the financial network profile. Subsequently, the financial social network server computer executes a loan transaction with one of the members of the financial social network at a loan rate equal to the base financial rate.

### BACKGROUND OF THE INVENTION

Groups such as social networks are popular since they enable people of similar interests to join together and share information such as messages, pictures, links to web sites, etc. Members of social networks tend to come from similar backgrounds and benefit from these social interactions accordingly.

The present invention leverages the infrastructure of these social networks and other types of groups to provide a dynamic financial services and data network in which each member participates to the benefit of all members.

### SUMMARY OF THE INVENTION

Provided is a method of and system for operating a financial-based and data social network. A financial social network server computer forms a financial social network comprising a plurality of members linked to each other via the financial social network server computer. The financial social network server computer generates a financial member profile for each member of the financial social network. The financial social network server computer then generates a financial network profile based on an analysis of the financial member profiles of the members of the financial social network. Then the financial social network server computer generates a base financial rate of the financial social network as a function of the financial network profile. Subsequently, the financial social network server computer executes a financial transaction (such as but not limited to a loan, purchase or option) with one or more of the members of the financial social network at a loan rate equal to the base financial rate.

For example, the financial social network server computer may generate a financial member profile for each member by obtaining financial information about the member from an external source (such as a credit score of the member), or by obtaining financial information about the member from the member.

Periodically, the financial social network server computer receives revised financial information about a member, then updates the financial member profile of the member as well as the financial network profile as a function of the updated financial member profile. The financial social network server computer then generates an adjusted financial rate of the financial social network as a function of the updated financial network profile, and it revises the loan transaction so the loan rate is equal to the adjusted financial rate.

### BRIEF DESCRIPTION OF THE DRAWING

FIG. 1 is a flowchart of the basic operation of the present invention.

FIG. 2 is a block diagram of the system of the present invention.

FIG. 3 is a screen shot of a dashboard used with the present invention.

### DETAILED DESCRIPTION OF THE INVENTION

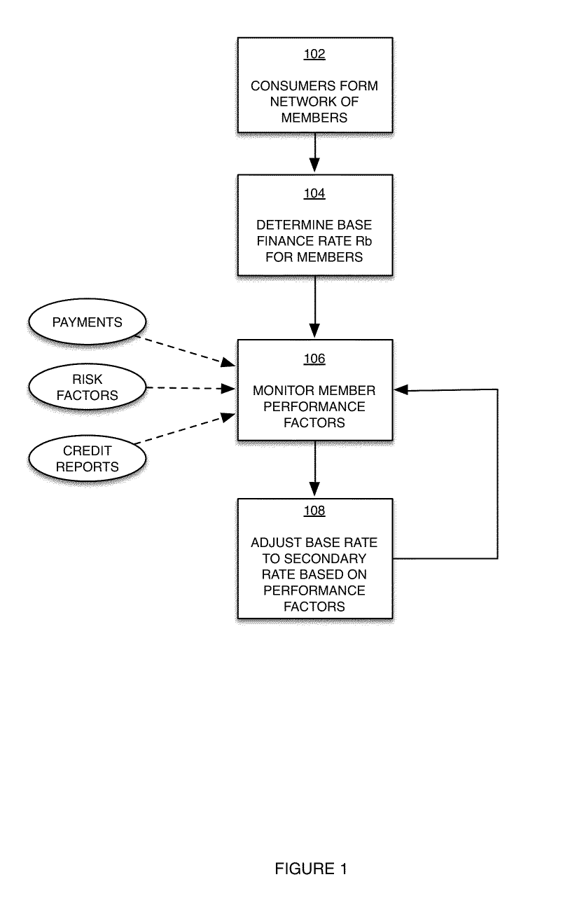

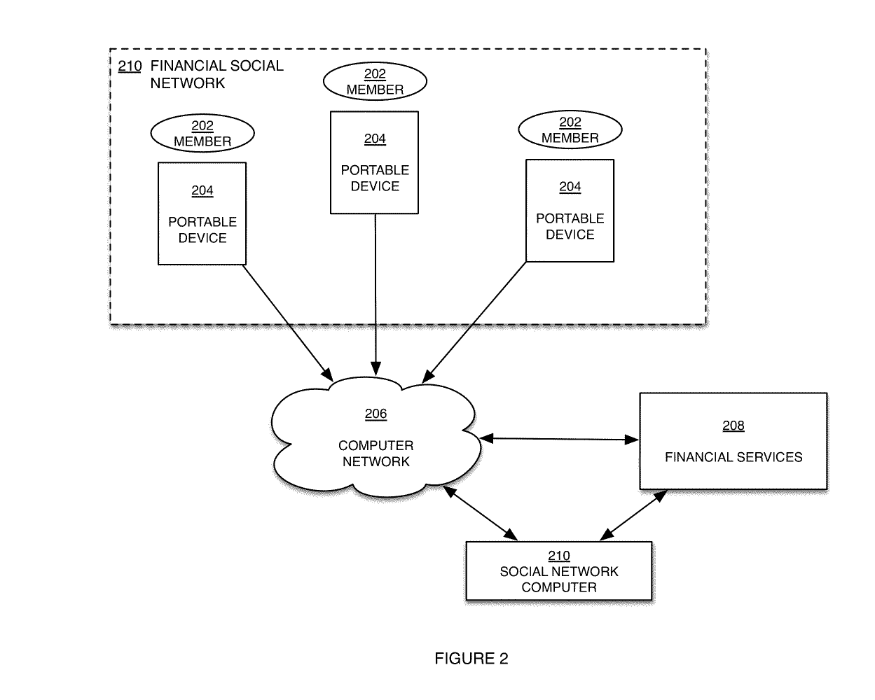

In the present invention, consumers form groups of members to provide a commonality that is advantageous in obtaining favorable financial terms for those members from an affiliated bank or other financial services provider. As shown by the flowchart in FIG. 1, a group of consumers form a network of members in step 102. FIG. 2 illustrates this as the members 202, which collectively form a financial social network 210. Each of the members uses a portable device 204 such as a smartphone (e.g., IPHONE, ANDROID phone, and the like), or a tablet such as an IPAD, and the like. The portable devices 204 provide computing capabilities, program and data storage, input devices such as buttons and a touchscreen, output devices such as a speaker and a touchscreen, and wireless communications circuitry suitable for enabling communications over voice and data networks such as the Internet 206. This functionality is well known in the art and need not be described in any further detail. Other devices may be used in place of the portable device 204, such as laptop computers, desktop computers, web-enabled interactive TVs, etc.

Also shown in FIG. 2 is a financial services computer 208, which may be a single server computer or a group of server computers that operate to perform the functions that will be described herein with respect to the flowchart of FIG. 1. For example, the financial services computer 208 may determine a loan rate for all members of the financial social network 210 as described below.

As shown in FIG. 1, in step 102 a group of consumers may associate together to form the financial social network 210. The manner of association may take on many forms. In one case, a social network such as those implemented by social networking services such as FACEBOOK may be adapted under this invention. In another case, a group of members may join with each other specifically for implementing this invention. When an existing social network service such as FACEBOOK is used, then a social network computer 210 will interoperate with the members 202 via the network 206, and it will interoperate with the financial services computer 208 through the network 206 or directly as shown. In the alternative, some or all of the functions performed by the financial services computer 208 may be performed instead by the social network computer 210. In this embodiment the social network computer 210 already possesses much information about its members and about the social networks of its members and can perform the analyses described herein, after which it can hand off the results of such analyses to the financial services computer to enable it to execute the applicable financial transactions as described.

In yet another case, a service may be offered to selected members of the public by the financial services provider. In this case, the financial services computer 208 forms the social network with members 202 that request to join and are accepted into a given social network. The financial services provider may invite selected consumers to join with each other based on criteria such as income level of the consumers, socio-economic status level of the consumers, occupation, and the like. The financial services provider may form virtually any type of financial social network utilizing any criteria as may be desired. As mentioned above, this may be done in conjunction with the social network computer 210.

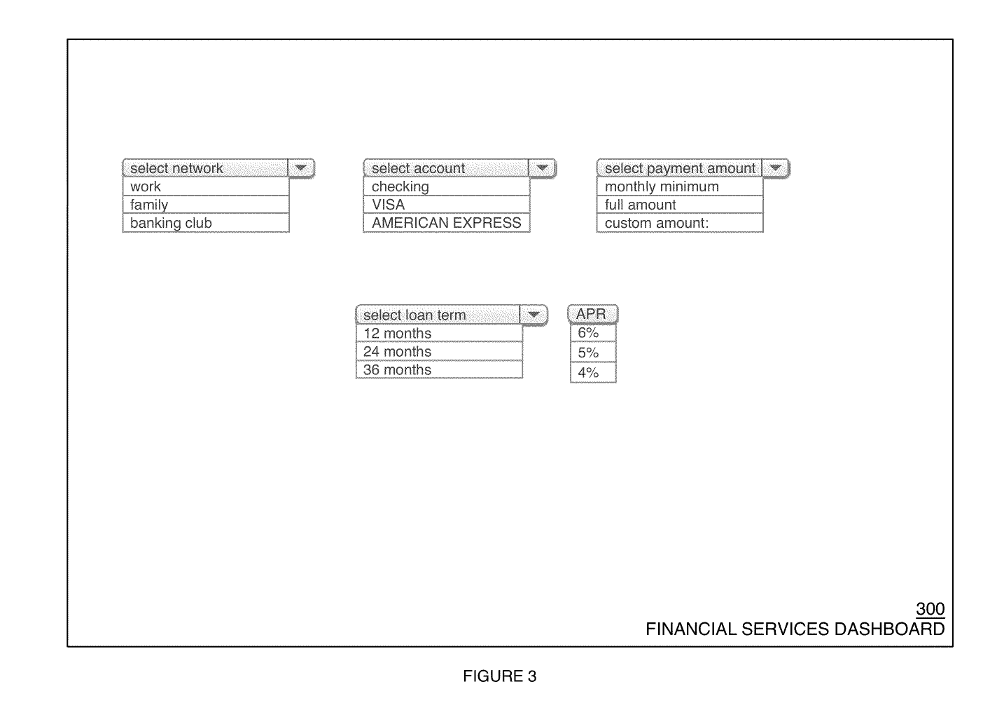

Members 202 may be provided with a dashboard web page served by the financial services computer 208 that provides various pieces of information and controls regarding the network 210. An example of such as dashboard is shown in FIG. 3. For example, a member 202 may be able to select which network he would like to join as well as certain financing terms and specify which, if any, pre-existing accounts may be swept into an account controlled by the present invention. For example, the member 202 may elect, via the dashboard web page, to have his VISA and TARGET credit cards paid off with an installment loan under this system, etc. The member may be able to specify the term of the installment loan provided, with interest rates (base and adjusted) displayed as a function of the loan term. Thus, by changing the term of the proposed loan, the applicable rate will vary and be displayed to the user to enable him or her to make an informed choice.

In step 104, the financial services computer determines a base finance rate Rb for all members 202 of the financial social network 210. The base finance rate Rb may be determined as a function of various factors, such as but not limited to market conditions, available financing from other sources, and the like. In particular, the base rate Rb will be determined as a function of various risk factors associated with each member 202. These risk factors, including but not limited to credit report scores and income level, are used to calculate an overall risk factor for each member. The analysis will have multiple vertical capabilities and utilize social data and psychographic data for behavior analysis as well.

By analyzing the risk factors for all of the members of the network 210 with respect to market conditions and the like, the base finance rate is calculated. For example, a standard finance rate may be 5%, but if the members of the network have demonstrated an overall risk factor less than that of the general public, then all members of that network may get a reduced base rate of 4%.

In this example, all of the members of the network will receive the same base finance rate Rb regardless of their individual risk factors. Thus, any member with a higher risk factor than the average of the network will benefit, while any member with a lower risk factor than the average of the network will not benefit. By assessing the risk factors of the network as a whole, the base rate provided to each and every member of that network is determined. This provides an incentive to members of the network to allow new members who have a lower risk factor which will help lower the base finance rate, rather than new members who have a higher risk factor which will raise the base finance rate.

As described above, the base finance rate Rb is provided by the financial services computer 208 to all members 202 of the financial social network 210. This is used by the financial services computer in extending loans, lines of credit and the like. In one embodiment, a member 202 may make a purchase using an account linked to an application executing on his or her portable device 204, and that account is subject to the base financial rate provided by the financial services computer 208. In this respect, the financial services computer and the financial service provider that runs the computer 208 provides financing of transactions executed by the member 202 at the base financial rate Rb. In another embodiment, the member 20 is able to consolidate some or all of his or her payment accounts into a single account that is financed by the financial services provider via the financial services computer 208. Other manners of financing are contemplated by and included within the scope of this invention.

Referring back to FIG. 1, the next step in the process is for the financial services computer 208 to monitor various performance factors of each of the members at step 106. For example, the same criteria used to calculate the base rate may be continuously monitored in the event they may improve or worsen. Additionally, payments made by the members in payment of their accounts with the financial service provider maybe monitored by the computer 208.

At step 108, the base rate is adjusted upwards or downwards based on the monitoring step 106, which yields the secondary rate or adjusted rate. Thus, if the network 210 is performing well as a whole, based on the analysis of the performance of each of its constituent members, then the entire network will enjoy a downward adjustment of the base rate to provide a lower secondary rate. The difference between the base rate and the secondary rate in this case is the discount. Likewise, if the network 210 is performing poorly as a whole, based on the analysis of the performance of each of its constituent members, then the entire network will suffer from an upward adjustment of the base rate to provide a higher secondary rate. The difference between the base rate and the secondary rate in this case is the premium.

As shown in FIG. 1, this process repeats so that the finance rate provided to the members of the network is continuously updated to reflect the performance of the network, which is analyzed as a function of its constituent members. This may be done on any schedule, as may be desired, e.g. hourly, daily, weekly, monthly, etc. As such, it may be considered to be a floating rate since it may be adjusted in a real-time basis.

In an embodiment of the invention, and in the particular case of an installment loan, the rate may be fixed but the financial services provider may assess service fees commensurate with the calculated rate adjustment. That is, optionally rather than adjusting the rate of the installment loan as described above based on performance factors of the members, the financial services provider may assess a service fee (or provide a credit as the case may be) and keep the rate the same in lieu of increasing or decreasing the rate charged to the member.

More than one level of the adjusted rate may be established if desired. That is, the financial service provider may provide a low risk adjusted rate, a high risk adjusted rate, an extremely high risk adjusted rate, etc. These various levels may coexist and be offered to various members of the groups as appropriate in accordance with each member's particular status and level of performance. These various rates may therefore be stacked and aggregated.

Put another way, there is a base rate, a secondary rate, a tertiary rate, etc., which can be assigned accordingly to high performance members as desired. That is, all rates need not apply to everyone.

In an alternative embodiment, both the base rate and the adjusted rate (the premium rate) may be used in a bifurcated system. As such, the base rate is a fixed rate and the adjusted rate is a floating rate that varies as described above. Both rates may be used and selected based on certain criteria as may be desired.

In one embodiment, the members of the network may be given special access to view the performance and risk factors of other members of the network. This access may allow viewing other members' performance factors with or without obtaining their name or other identifying indicia (e.g. in an anonymous fashion). In the case where the members' names are accessed, the reviewing members may be able to interact with those members who may be performing poorly (e.g. paying late) and thus causing the adjusted base rate to increase to the detriment of all members of the network.

In another embodiment, the network may establish certain performance criteria that, if met, will cause the offending member to be automatically suspended or even terminated from the network. For example, a rule may be established wherein any member with a credit score under 500 is suspended, and then terminated if not corrected with one month, etc. Or, certain members may have restrictions on using the network if they fall below a certain minimum standard. Members of the network may be allowed to vote on these performance criteria as the case may be.

Notifications and warning may be provided by the financial services computer 208 to any or all of the members 202 of the financial social network 210 prior to or at the same time that certain triggering events may occur, including a change in the adjusted rate (optionally over a predetermined threshold amount), changes to a particular member's performance and risk factors that may change the adjusted rate (adversely or beneficially), and the like. For example, a warning could be provided to a group of members 202 that states that the adjusted rate will increase in three days unless certain loan payments are made prior to that date.

Referral fees and benefits may be made available to members for referring other new members into the network. For example, a member may be able to obtain a late payment charge forgiven if he is able to refer three new members in a month, etc.

The financial services provider may negotiate a settlement with individual members or groups/communities of members if desired, for example, in instances of non-performance, late payments etc. For example the provider could request a member to pay of half of his balance in exchange for a reduced interest rate.

Anonymous accounts may be established in conjunction with this invention. For example, unbanked or undocumented people may be able to obtain an anonymous debit account linked to the present invention.

In an alternative embodiment, a crowdsource functionality is employed wherein members of the financial social network join together to obtain a loan from a financial institution. The loan terms are based on the aggregate financial profile of the members that take part of the crowdsourced loan.

Thus, these members form an ad hoc financial social network for the purpose of obtaining a loan, and that loan may be apportioned amongst those members. Each member is then responsible for repayment of the loan proportionate to the amount that he or she has obtained form the overall loan.

As such, the bargaining power of the ad hoc financial social network is leveraged to the benefit of each member. Alternatively, each member could be secondarily liable to the financial institution for repayment of any defaulting member, thus decreasing the risk of the crowdsourced loan provided by the institution. Members of this financial social network may be required of course to meet a certain financial profile in order to participate in the crowdsourced loan. Note that this functions in the same way as an investment club, providing a bulk rate discount to each of the members.

Similarly, the crowdsource functionality of this invention may be used to form a financial social network that grants loans to other members or non-members, as the case may be. In this embodiment, the financial network profile is used to set terms of the loan as well.

What is claimed is:

1. A method of operating a financial-based social network comprising:
a financial social network server computer forming a financial social network comprising a plurality of members linked to each other via the financial social network server computer,
the financial social network server computer generating a financial member profile for each member of the financial social network;
the financial social network server computer generating a financial network profile based on an analysis of the financial member profiles of the members of the financial social network;
the financial social network server computer generating a base financial rate of the financial social network as a function of the financial network profile; and
the financial social network server computer executing a loan transaction with one of the members of the financial social network at a loan rate equal to the base financial rate.

2. The method of claim 1 wherein the financial social network server computer generates a financial member profile for each member by obtaining financial information about the member from an external source.

3. The method of claim 1 wherein the financial information comprises a credit score of the member.

4. The method of claim 1 wherein the financial social network server computer generates a financial member profile for each member by obtaining financial information about the member from the member.

5. The method of claim 1 further comprising the financial social network server computer receiving revised financial information about a member;
the financial social network server computer updating the financial member profile of the member;
the financial social network server computer updating the financial network profile as a function of the updated financial member profile;
the financial social network server computer generating an adjusted financial rate of the financial social network as a function of the updated financial network profile; and
the financial social network server computer revising the loan transaction so the loan rate is equal to the adjusted financial rate.

6. A system for operating a financial-based social network comprising:
a financial social network server computer interconnected via a computer network with a plurality of user computing devices, the financial social network server computer programmed to
form a financial social network comprising a plurality of members linked to each other via the financial social network server computer,
generate a financial member profile for each member of the financial social network;
generate a financial network profile based on an analysis of the financial member profiles of the members of the financial social network;
generate a base financial rate of the financial social network as a function of the financial network profile; and
execute a loan transaction with one of the members of the financial social network at a loan rate equal to the base financial rate.

7. The system of claim 6 wherein the financial social network server computer is programmed to generate a financial member profile for each member by obtaining financial information about the member from an external source.

8. The system of claim 6 wherein the financial information comprises a credit score of the member.

9. The system of claim 6 wherein the financial social network server computer is programmed to generate a financial member profile for each member by obtaining financial information about the member from the member via the user computing device.

10. The system of claim 6 wherein the financial social network server computer is further programmed to
receive revised financial information about a member;
update the financial member profile of the member;
update the financial network profile as a function of the updated financial member profile;
generate an adjusted financial rate of the financial social network as a function of the updated financial network profile; and
revise the loan transaction so the loan rate is equal to the adjusted financial rate.

11. A financial social network server computer interconnected via a computer network with a plurality of user computing devices, the financial social network server computer programmed to
form a financial social network comprising a plurality of members linked to each other via the financial social network server computer,
generate a financial member profile for each member of the financial social network;
generate a financial network profile based on an analysis of the financial member profiles of the members of the financial social network;
generate a base financial rate of the financial social network as a function of the financial network profile; and
execute a loan transaction with one of the members of the financial social network at a loan rate equal to the base financial rate.

12. The financial social network server computer of claim 11 programmed to generate a financial member profile for each member by obtaining financial information about the member from an external source.

13. The financial social network server computer of claim 11 wherein the financial information comprises a credit score of the member.

14. The financial social network server computer of claim 11 programmed to generate a financial member profile for each member by obtaining financial information about the member from the member via the user computing device.

15. The financial social network server computer of claim 11 further programmed to
receive revised financial information about a member;
update the financial member profile of the member;
update the financial network profile as a function of the updated financial member profile;
generate an adjusted financial rate of the financial social network as a function of the updated financial network profile; and
revise the loan transaction so the loan rate is equal to the adjusted financial rate.
